(19) United States
(12) Patent Application Publication
(10) Pub. No.: US 2009/0170214 A1
(43) Pub. Date: Jul. 2, 2009

(54) Luminescent Reporter Modality for Analyzing an Assay

(75) Inventors: Oliver H. Meek, Austin, TX (US); Roland Schneider, Austin, TX (US); Harold N. Baker, Austin, TX (US)

Correspondence Address: DAFFER MCDANIEL LLP, P.O. BOX 684908, AUSTIN, TX, 78768, US

(73) Assignee: LUMINEX CORPORATION, Austin, TX (US)

(21) Appl. No.: 12/345,285

(22) Filed: Dec. 29, 2008

Related U.S. Application Data
(60) Provisional application No. 61/016,879, filed on Dec. 27, 2007.

(51) Int. Cl. G01N 21/64; G01N 21/76

(52) U.S. Cl. 436/172; 422/52

(57) ABSTRACT

An optical analysis flow system and a method of assay analysis includes a means for facilitating activation of a luminescent material coupled to particles entrained within a fluid assay, wherein the means is arranged such that the activation of the luminescent material is conducted at a site along a flow path of the fluid assay prior to an examination zone of the optical analysis flow system. The method further includes measuring luminescent light emitting from the particles as they flow through the examination zone. Another method of assay analysis includes respectively measuring different types of luminescent light emission from a first set and a second set of particles comprising a fluid assay. An optical analysis system includes at least two distinct means for respectively facilitating the activation of at least two different luminescent materials coupled to particles of a fluid assay.

### PRIORITY CLAIM

The captioned application claims priority to prior U.S. Provisional Application No. 61/016,879 filed Dec. 27, 2007.

### BACKGROUND OF THE INVENTION

1. Field of the Invention

This invention generally relates to systems and methods for analyzing assays, and more specifically, to optical systems and methods for analyzing assays using luminescent reporters.

2. Description of the Related Art

The following descriptions and examples are not admitted to be prior art by virtue of their inclusion within this section.

Spectroscopic techniques are widely employed in the analysis of chemical and biological assays. Most often, these techniques involve measuring the absorption or emission of electromagnetic radiation by the material of interest. One such application is in the field of microarrays, which is a technology exploited by a large number of disciplines including the combinatorial chemistry and biological assay industries. Luminex Corporation of Austin, Tex. has developed systems in which assays are analyzed through detection of fluorescence emissions from the surface of variously colored fluorescent microspheres. In such systems, a multiplexing scheme is often employed in which multiple analytes are evaluated in a single analysis step for a single sample. To facilitate a multiplexing scheme, particles are configured into distinguishable groups, with different groups used to indicate the presence, absence and/or amount of different analytes in an assay. For instance, different fluorescent dyes and/or different concentrations of dyes may be absorbed into particles and/or bound to the surface of particles and/or particles may vary by size. Contemporary systems using these microspheres can test for tens to over one hundred different analytes in a biological sample and future increases are probable. In particular, the number of particle categories may be augmented by increasing the number of fluorescent dyes and/or different dye intensities. The inclusion of additional dyes and/or dye intensities, however, adds complexity to a system, which can greatly contribute to increasing the expense and/or difficulty of producing the platform.

An alternative to detecting fluorescent emissions for assay analysis is chemiluminescent emission detection, specifically via a chemiluminescent reaction between particles coupled with a chemiluminescent compound and a trigger solution added to an assay including the particles. Such a manner of detection, however, typically requires the particles to be immobilized to adequately activate and measure the chemiluminescence. In particular, the emission kinetics of a typical chemiluminescent reaction generally occurs on the order of a few hundred microseconds after a trigger solution is introduced to an assay. As such, in order to ensure luminescent emission is captured, particles within an assay are immobilized prior to introduction of a trigger solution and remain immobilized for the subsequent measurement of chemiluminescence. For at least this reason, chemiluminescent detection is not considered feasible for flow systems and, thus, is generally performed with a static luminometer or a plate reader.

### SUMMARY OF THE INVENTION

The following description of various embodiments of optical analysis systems and methods for analyzing an assay is not to be construed in any way as limiting the subject matter of the appended claims.

An embodiment of a method for analyzing an assay within an optical analysis flow system includes injecting a fluid assay comprising particles coupled with a luminescent compound into an optical analysis flow system. The method further includes activating the luminescent compound on at least some of the particles within the optical analysis flow system at a site along a flow path of the fluid assay prior to an examination zone of the optical analysis flow system such that the particles coupled with the activated luminescent compound emit luminescent light within the examination zone. Moreover, the method includes measuring the luminescent light emitting from the particles coupled with the activated luminescent compound as they flow through the examination zone.

An embodiment of an optical analysis flow system includes an interrogation flow cell and a fluid handling system including a sheath fluidic line for supplying a sheath fluid into the interrogation flow cell and an assay fluidic line extending into the interrogation flow cell for introducing a fluid assay into a flow of the sheath fluid within the interrogation flow cell. The optical analysis flow system also includes a means for facilitating activation of a luminescent material coupled to particles entrained within the fluid assay. The means for facilitating activation of the luminescent material is arranged such that the activation of the luminescent material is conducted at a site along a flow path of the fluid assay prior to an examination zone of the interrogation flow cell.

Another embodiment of a method for analyzing an assay includes introducing a fluid assay into an optical analysis system, measuring a first type of luminescent light emission from a first set of particles comprising the fluid assay, and measuring a second distinct type of luminescent light emission from a second set of particles comprising the fluid assay.

An embodiment of an optical analysis system includes a particle examination chamber and an assay fluidic line distinct from the particle examination chamber, but operably coupled to the particle examination chamber such that particles entrained within a fluid assay flowing in the assay fluidic line are routed to the particle examination chamber. In addition, the optical analysis system includes at least two distinct means for respectively facilitating the activation of at least two different luminescent materials coupled to the particles.

### BRIEF DESCRIPTION OF THE DRAWINGS

Other objects and advantages of the invention will become apparent upon reading the following detailed description and upon reference to the accompanying drawings in which:

FIG. 1 illustrates a schematic drawing of an exemplary optical analysis system;

FIG. 2a illustrates a partial cross-sectional view of an exemplary interrogation flow cell assembly and other components of an optical analysis flow system;

FIG. 2b illustrates a partial cross-sectional view of a different configuration of an interrogation flow cell assembly and other components of an optical analysis flow system;

FIG. 2c illustrates a partial cross-sectional view of another different configuration of an interrogation flow cell assembly and other components of an optical analysis flow system;

FIG. 2d illustrates a partial cross-sectional view of yet another different configuration of an interrogation flow cell assembly and other components of an optical analysis flow system;

FIG. 3 illustrates a partial cross-sectional view of yet another different configuration of an interrogation flow cell assembly and other components of an optical analysis flow system;

FIG. 4 illustrates a flowchart of an exemplary method for analyzing an assay; and

FIG. 5 illustrates a flowchart of another exemplary method for analyzing an assay.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

In general, the optical analysis systems and methods described herein are directed at facilitating alternative and/or additional manners in which to analyze a fluid assay. Some of the systems and methods described herein are particularly directed at configurations which allow assay analysis using non-fluorescent reporters in an optical analysis flow system, particularly non-fluorescent luminescent materials which have a prolonged and/or delayed light emission upon activation. Such systems and methods include a means for facilitating activation of luminescent material coupled to particles entrained within the fluid assay. The means is arranged such that the activation of the luminescent material is conducted at a site along a flow path of the fluid assay prior to an examination zone of an interrogation flow cell and further such that the particles coupled with the activated luminescent compound emit luminescent light within the examination zone.

Other systems and methods described herein are directed at configurations which allow multiple and different types of luminescent reporters to be used to analyze a single assay in any type of optical analysis system (i.e., the systems and methods are not restricted to flow systems). Such systems and methods are described herein as measuring “different types of luminescent light”, which may generally refer to measuring luminescence generated from different manners of activation (e.g., photoluminescence, fluorescence, phosphorescence, chemiluminescence, bioluminescence, crystalloluminescence, electroluminescence, cathodoluminescence, mechanolumnescence, triboluminescence, fractoluminescence, piezoluminescence, radioluminescence, sonoluminescence, and thermoluminescence). As set forth below, systems and methods which are configured to measure different types of luminescent light may increase the number of analytes which may be identified and quantified from a single assay, particularly without increasing the expense and/or difficulty of producing a platform to analyze the assay.

The term “particle” is used herein to generally refer to microspheres, polystyrene beads, quantum dots, nanodots, nanoparticles, nanoshells, beads, microbeads, latex particles, latex beads, fluorescent beads, fluorescent particles, colored particles, colored beads, tissue, cells, micro-organisms, organic matter, non-organic matter, or any other discrete substrates or substances known in the art. Any of such terms may be used interchangeably herein. Exemplary magnetic microspheres which may be used for the methods and systems described herein include xMAP® microspheres, which may be obtained commercially from Luminex Corporation of Austin, Tex.

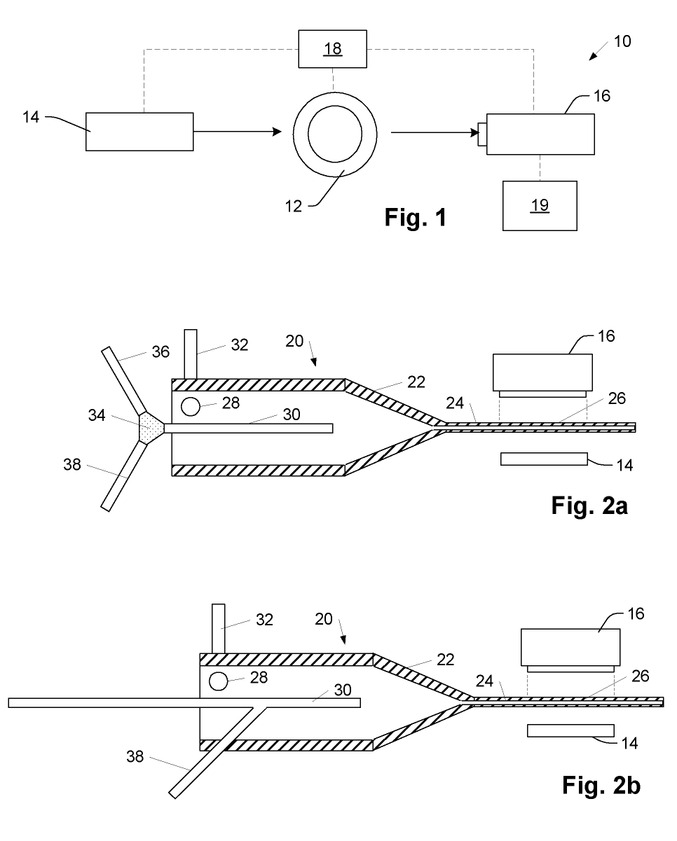

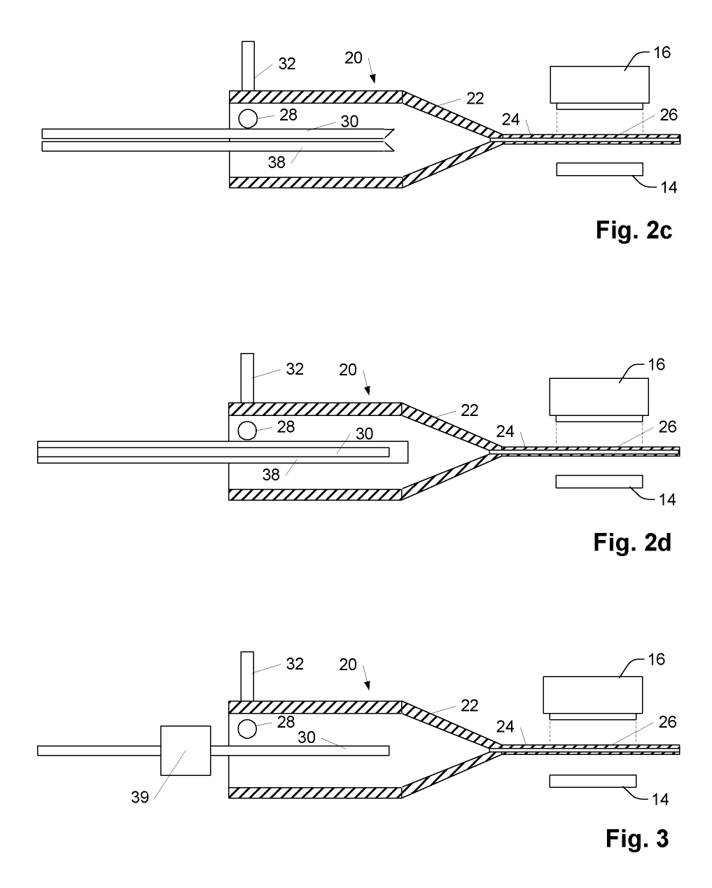

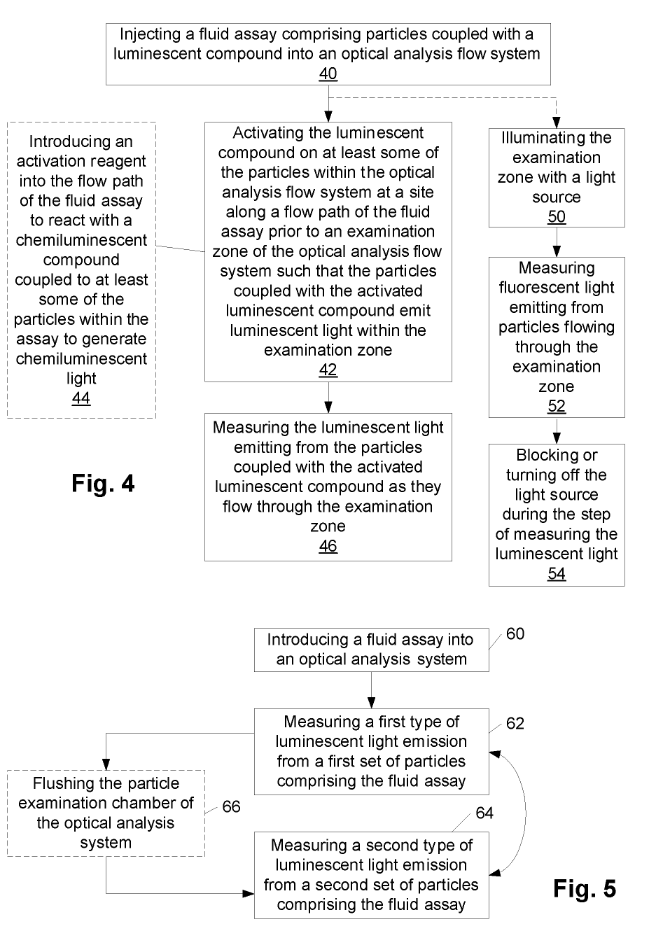

Turning to the drawings, exemplary optical analysis systems, fluidic line assemblies, and methods for analyzing as assay are shown. In particular, FIG. 1 illustrates a schematic drawing of an exemplary optical analysis system, which as described below may be representative of an optical analysis flow system or a static imaging optical analysis system. FIGS. 2a-2d and 3 illustrate partial cross-sectional views of exemplary interrogation flow cell assemblies as well as other components which may be used in optical analysis flow systems. FIGS. 4 and 5 respectively illustrate flow charts of exemplary methods for analyzing an assay using the optical analysis systems described herein, particularly but not limited to those described in reference to FIGS. 1-3. It is noted that the figures are not necessarily drawn to scale. In particular, the scale of some elements in some of the figures may be greatly exaggerated to emphasize characteristics of the elements. In addition, it is further noted that the figures are not drawn to the same scale. Moreover, for the sake of simplicity, the figures do not depict all components which may be included in the systems and assemblies described herein. Thus, the systems and assemblies described herein should not necessarily be restricted to the depictions in the figures.

As shown in FIG. 1, optical analysis system 10 may include particle examination chamber 12, illumination system 14, detection system 16, control system 18, and examination system 19. Although not shown in FIG. 1, optical analysis system 10 may further include a fluidic line assembly configured to transport a fluid assay including a multitude of particles to and from particle examination chamber 12. In particular, the fluidic handling system may include an assembly of valves, pumps and fluid pathways for introducing an assay and possibly other fluids into particle examination chamber 12 and additional fluid pathways for expelling the assay and possibly other fluids as waste. In general, the term “particle examination chamber”, as used herein, may generally refer to a location within an optical analysis system at which measurements of particles are taken.

In some cases, optical analysis system 10 may be a flow system and, therefore, the fluid pathways may include an interrogation flow cell. The term “interrogation flow cell” as used herein, may generally refer to an analysis vessel used to guide a flowing assay and having a portion (i.e., an examination zone) which is transparent such that measurements of particles may be taken as they are motion. In reference to FIG. 1, particle examination chamber 12 may be an examination zone of an interrogation flow cell when optical analysis system 10 is a flow system. In some cases, an interrogation flow cell may be configured to focus an assay such that at least some of the particles entrained therein may be individually interrogated. An exemplary optical analysis flow system which commonly includes such an interrogation flow cell configuration and which may be particularly suitable for the methods described herein is a flow cytometer. The discussions set forth below in reference to FIGS. 2a-3 are directed to flow cytometers configured to hydrodynamically focus an assay via a sheath fluid such that particles for the most part successively flow through an examination zone of an interrogation flow cell. The systems and methods described herein, however, are not necessarily so limited. In particular, other flow systems may also be applicable for the systems and methods described herein including but not limited to spectrometers, chromatographers, and other configurations of flow cytometers.

As set forth in more detail below, optical analysis systems which immobilize particles for examination may also be applicable for the systems and methods described herein. As such, optical analysis system 10 may be representative of static optical analysis systems in some embodiments, specifically static imaging systems. In such cases, optical analysis system 10 may still include a fluidic handling system for transporting a fluid assay and possibly other fluids to particle examination chamber 12, but the examination chamber may be generally configured to immobilize particles of the fluid assay for examination. Exemplary static imaging optical analysis systems having such a configuration are described in the U.S. patent application Ser. No. 11/757,841 entitled “Systems and Methods for Performing Measurements of One or More Materials” by Roth et al. filed on Jun. 4, 2007, which is incorporated by reference as if set forth fully herein.

As shown in FIG. 1, optical analysis system 10 may include illumination system 14 and detection system 16 disposed on either side of particle examination chamber 12. In general, detection system 16 may be configured to collect light emitted and/or scattered from particles in particle examination chamber 12. More specifically, detection system 16 may include one or more photodetectors configured to measure light emitted and/or scattered from particles passing through or immobilized at particle examination chamber 12 to determine the type and/or amount of analytes within a sample. The photodetectors may include avalanche photodiodes (APDs), a photomultipler tubes (PMTs), a charge-coupled device (CCD) array, or another type of photodetector. In addition, detection system 16 may include any number of filters, mirrors, and lenses. In some cases, however, it may be advantageous for detection system 16 to be void of filters or be configured to remove filters during some types of luminescent detection such that a wide bandwidth of light may be transmitted to the photodetectors. In any case, it is to be understood that detection system 16 may be configured to collect the light at any suitable angle of incidence although detection system 16 and, thus, optical analysis system 10 should not be limited to the depiction of collecting light at a substantially normal angle of incidence as shown in FIG. 1.

As set forth below, optical analysis system 10 may, in some embodiments, be configured to generate and measure different types of luminescent light for the identification and quantification of analytes within an assay. As such, detection system 16 may, in some embodiments, be used to measure different types of luminescent light emitted and/or scattered from particles. In order to accommodate such functionality, detection system 16 may, in some cases, include distinct sets of photodetectors arranged with respect to different locations along particle examination chamber 12 for detecting the distinct types of luminescent light emissions. In other embodiments, detection system 16 may include a single set of photodetectors arranged with respect to a single location along particle examination chamber 12 and optical analysis system 10 may be configured to segregate the detection of the distinct types of luminescent light emissions by isolating the activation of the different luminescent light materials coupled to or incorporated within particles. In particular, optical analysis system 10 may include a plurality of mechanisms for facilitating the activation of different luminescent materials to generate different types of luminescent light emissions and may be further configured to selectively employ such multiple mechanisms. In other embodiments, optical analysis system 10 may be used to measure a single type of luminescent light and, thus, may, in some cases, include a single means for facilitating the activation of a particular type of luminescent material. Examples of mechanisms for facilitating the activation of luminescent materials within optical analysis system 10 are described in more detail below.

For instance, illumination system 14 may be used to illuminate particle examination chamber 12 such that one or more photoluminescent materials coupled to particles within an assay emit fluorescence as they pass through or are immobilized within particle examination chamber 12. As noted above, optical analysis system 10 may, in some embodiments, be configured to generate and measure different types of luminescent light. For example, optical analysis system 10 may be configured to generate fluorescent light via illumination system 14 and may further be configured to generate another type of luminescent light by another means. Example of mechanisms for generating luminescent light other than fluorescent light are described in more detail below in reference to FIGS. 2a-3. In some cases, illumination of particle examination chamber 12 may mask the detection of other types of luminescent light and, therefore, optical analysis system 10 may be configured to block and/or turn off illumination system 14 for the detection of such light. In other embodiments, detection system 16 may be configured to differentiate different types of luminescent light thru the use of filters and, thus, blocking or turning off illumination 14 may not be necessary. In yet other embodiments, optical analysis system 10 may not be used to measure fluorescent emissions and, thus, illumination system 14 may be omitted from optical analysis system 10 in some cases. In particular, the inclusion of illumination system 14 within optical analysis system 10 is optional and may generally depend on whether optical analysis system 10 may be used for the detection of fluorescence emissions.

In general, illumination system 14 may include any suitable light source known in the art, such as but not limited to light emitting diodes (LEDs), lasers, arc lamps, fiber illuminators, light bulbs, and incandescent lamps. Illumination system 14 may include any number of the aforementioned light sources, including multiple sources of the same type of light source or different light sources. One example of an appropriate combination of light sources which may be particular useful for the system shown in FIG. 1 includes, but is not limited to, two or more lasers, particularly green and red lasers. In particular, green and red lasers may offer light at a sufficient spectral window (i.e., wavelength or band of wavelengths) to allow the system to be void of spectral filters, simplifying the system. In addition to including one or more light sources, illumination system 14 may include other optical components, such as but not limited to beamsplitters, reflecting mirrors, collimating lenses, spectral filters, neutral density filters, polarizing components, diffusers, and/or homogenizers. In some embodiments, illumination system 14 may be configured to sequentially illuminate particles with different wavelengths or wavelength bands of light (e.g., blue light and green light), such that the light directed to the particles is monochromatic, near monochromatic, polychromatic, or broadband. In any case, although the system in FIG. 1 is shown to direct light to particle examination chamber 12 at a substantially normal angle of incidence, it is to be understood that the system may be configured to direct the light to the particle examination chamber at any other suitable angle of incidence.

As further shown in FIG. 1, optical system 10 may include control system 18 operatively coupled to illumination system 14, particle examination chamber 12, and detection system 16. In general, control system 18 may be configured to automate the operations of optical analysis system 10. For example, in embodiments in which detection system 16 includes distinct readers for detecting distinct types of luminescent light, control system 18 may be configured to select an appropriate detection reader to measure the light generated within particle examination chamber 12 based on which mechanism is employed to activate luminescent materials within optical analysis system 10. In other cases, the distinct detectors may be used concurrently and, thus, selection by control system 18 may not be needed.

In either case, control system 18 may, in some embodiments, be configured to block and/or turn illumination system 14 on and off. Such a configuration may be particularly applicable when the light generated from illumination system 14 may mask light generated from non-fluorescent luminescent material coupled to particles within an assay. Alternatively, illumination system 14 may be kept on while non-fluorescent luminescent light is measured by detection system 16, particularly if detection system 16 includes a filter to exclude the light from illumination system 14. In yet other embodiments, control system 18 and/or illumination system 14 may be configured to pulse light upon particle examination chamber 12. In any case, another application that control system 18 may be used to govern is the selective employment of mechanisms in optical analysis system 10 which facilitate the activation of luminescent compounds coupled to particles in an assay. Examples of such operations are described in more detail below in reference to FIG. 2.

As shown by the dotted line connection in FIG. 1, examination system 19 may be operably coupled to detection system 16. In general, examination system 19 may be configured to analyze the signals generated by detection system 16 regarding light collected from the particles. In particular, examination system 19 may include program instructions which are executable by a processor for associating signals generated by detection system 16 to classify particles to particular classification subsets and quantify analytes of interest corresponding to the classification subsets. In general, the classification of particles and the quantification of particular analytes of interest by examination system 19 may be based on the intensity of light collected for particular wavelengths of emissions associated with predefined classification channels.

As noted above, optical analysis system 10 may, in some embodiments, be configured to generate and measure different types of luminescent light. In such cases, the classification particle subsets used to detect and/or quantify analytes in an assay may include distinct subsets for the different types of luminescent light. Alternatively stated, different sets of classifications regions may be mapped out for each type of luminescent light. For example, examination system 19 may be configured to classify particles to 100 different classification regions based on fluorescent light emitted from particles and may be further configured to classify particles to a different set of 100 classification regions based on chemiluminescent light emitted from particles. In some embodiments, each classification region may be representative of a different analyte of interest. For example, in the scenario noted above, the system may be configured to detect and quantify up to 200 different analytes of interest. In yet other cases, the classification regions may be mapped out such that more than one classification region may represent a single analyte of interest. Such scenarios may be advantageous for verifying analyte detection and/or quantification within an assay.

In alternative embodiments, the classification subsets used to categorize particles may include similar or the same subsets for the different types of luminescent light. In other words, examination system 19 may be configured to classify different types of luminescent light to similar or the same classification regions. As set forth below, such a configuration may advantageously increase the capacity of an optical analysis system without having to implement software modifications to map out additional regions for particle classification. In particular, different analytes may be attributed to each classification region based on the luminescent light measured and, thus, the capacity of the system may effectively be a multiple of the number of different types of luminescent light the system is configured to measure.

For instance, in cases in which examination system 19 is configured to classify two different types of luminescence to the same 100 classification regions, each region may be representative of two different analytes and, thus, the optical analysis may be configured to detect and/or quantify 200 different analytes. In such embodiments, examination system 19 may be configured to differentiate between two analytes of interest for the same classification region based one or more different operational parameters of optical analysis system 10. Examples of parameters include but are not limited to whether illumination system 14 is turned off or blocked, which of a plurality of detectors in detection system 16 generated the signal, and/or whether a means for facilitating activation of a particular luminescent material is employed. Exemplary means for facilitating activation of particular luminescent materials within optical analysis system 10 are described in more detail below in reference to FIGS. 2a-3.

In particular, FIGS. 2a-3 illustrate partial cross-sectional views of exemplary interrogation flow cell assemblies and other components of flow systems arranged in proximity to the flow cell assemblies, which include different means for facilitating activation of luminescent materials in proximity to particle examination chambers of the flow cell assemblies. Many luminescent materials emit light shortly after being activated and/or have a short time span of emission and, thus, activating the materials in an assay prior to introducing the assay into an optical analysis system may not be prudent. As such, the optical analysis systems described herein include means for facilitating the activation of luminescent materials, particularly at sites along assay fluidic lines operably coupled and leading to particle examination chambers.

As set forth below, the configurations described in reference to FIGS. 2a-3 are designed such that a means for facilitating activation of luminescent material coupled to particles entrained within the fluid assay is arranged such that the activation of the luminescent material is conducted at a site along a flow path of the fluid assay prior to an examination zone of the interrogation flow cell. In addition, the means is arranged such that the particles coupled with the activated luminescent compound emit luminescent light within the examination zone. The configurations are particularly directed at using non-fluorescent reporters for assay analysis, particularly non-fluorescent luminescent materials which have a prolonged and/or delayed light emission upon activation. Due to nature of optical flow systems analyzing continuously flowing assays, such configurations may be particularly applicable but not limited to such systems. It is noted, however, that similar means may be incorporated within fluid handling systems of static imaging optical analysis systems and, thus, the discussion relative to FIGS. 2a-3 should not be limited to optical flow systems.

The position of a means for facilitating the activation of a luminescent material within an optical analysis system may vary among different applications and may generally depend on the design of the analysis system as well as the timing and/or duration of the luminescent material to emit light after being activated. In cases in which light generation after activation is delayed or prolonged for a relatively short amount of time, it may be advantageous to activate a luminescent material very close to a particle examination chamber. For example, it may be desirable to position a means for facilitating activation of a luminescent material such that the site of activation within an optical analysis system is along a flow path of a fluid assay less than approximately 1.0 inch from the particle examination chamber. Other positions relating to distance from a particle examination chamber, however, may be considered.

In some cases, the position of such a means may be described relative to the timing of activating a luminescent material and subsequently measuring its light emission within an optical analysis chamber. For instance, an optical analysis system may be configured with a means for facilitating activation of a luminescent material such that measuring the resultant light emission is performed less than approximately 500 milliseconds after the material is activated. To accommodate such timing, the luminescent compound/s may generally have emissions kinetics peaks less than approximately 500 ms after being triggered. In particular, such a range may be suitable for insuring luminescent light emission may be detected and measured in a particle examination zone chamber of the optical analysis systems described herein. Other positions of means for facilitating activation of a luminescent material relating to timings of particle travel, however, may be considered.

As noted above, the systems described herein may be configured to generate different types of luminescent light and, as such, any of the configurations described in reference to FIGS. 2a-3 may be combined to realize such functionality. In other cases, however, a system may include only one of the configurations described in reference to FIGS. 2a-3. In some embodiments, one or more of the configurations described in reference to FIGS. 2a-3 may be incorporated within an optical analysis system having an illumination system used to induce fluorescent light emission from particles in its particle examination chamber (i.e., such as illumination system 14 described in reference to FIG. 1).

As shown in FIGS. 2a-3, the interrogation flow cell assemblies are configured such that assay fluidic line 30 extends into interrogation flow cell 20. In addition to providing a manner for suspending assay fluidic line 30 within interrogation flow cell 20, the interrogation flow cell assemblies include sheath fluidic line 32 and opening 28 for introducing a sheath fluid into interrogation flow cell 20. As a result, sheath fluid may be introduced around assay fluidic line 30. It is noted that several different configurations of components for interrogation flow cell assemblies may be considered for the systems and methods described herein and, consequently, the systems and methods are not limited to the depictions of FIGS. 2a-3.

As further shown in FIGS. 2a-3, interrogation flow cell 20 may generally include focusing section 22 for receiving sheath and assay fluids as well as for hydrodynamically focusing such fluids into capillary section 24. As noted above in reference to FIG. 1, the systems described herein are equipped with photodetection systems for measuring light radiation from examination zones of interrogation flow cells and, thus, transparency of at least such examination zones is needed. As such, the term “interrogation flow cell”, as used herein, may generally refer to an analysis vessel used to guide a flowing assay and having a portion (i.e., an examination zone) which is transparent such that measurements of particles may be taken as they are motion. The term “cuvette” is often referenced as an interrogation flow cell of a flow system and, therefore, the terms may be used interchangeably herein. In general, the portion of capillary section 24 in alignment within detection system 16 in FIGS. 2a-3 (denoted by the dotted lines extending from detection system 16 to capillary section 24) may be regarded as examination zone 26 of interrogation flow cell 20. Illumination system 14 is shown in FIGS. 2a-3 on the opposing side of capillary section 24 in alignment with examination zone 26 and may generally be used to induce fluorescent light emissions from particles flowing through examination zone 26 as described above. As noted above, however, illumination system 14 is optional and, thus, may be omitted from the optical analysis systems described herein in some cases.

As described in more detail below in reference to FIGS. 2a-2d, the systems described herein may, in some embodiments, be configured to supply different assay fluids into interrogation flow cell 28. In particular, optical analysis system 10 may have distinct fluidic lines feeding into interrogation flow cell 28 and, in some cases, distinct pumps for respectively introducing the different assay fluids thru the fluidic lines. In this manner, assay fluids may be mixed together in proximity to and/or within interrogation flow cell 28. More specifically, the systems described herein may be configured to introduce, and in some embodiments be configured to selectively introduce, a reagent to an assay in proximity to examination zone 26. Such configurations may be particularly advantageous in embodiments in which an assay is going to be analyzed via chemiluminescence detection/measurements. In particular, the reagent added to an assay may, in some embodiments, be a reagent configured to react with a chemiluminescent compound coupled to particles within the assay. Examples of reagents with such functionality are described in more detail below in reference to FIG. 4, particularly block 44 of the flowchart depicted therein.

As shown in FIG. 2a, an exemplary means for introducing a reagent to an assay in proximity to examination zone 26 may include three-way valve 34. Three-way valve 34 includes an outlet port coupled to assay fluidic line 30, an assay inlet port coupled to assay inlet line 36 for introducing a fluid assay into assay fluidic line 30, and a reagent inlet port coupled to reagent fluidic line 38 for introducing a reagent into assay fluidic line 30. In some cases, three-way valve 34 may be operably coupled to a control system, such as control system 18 of optical analysis system 10 depicted in FIG. 1. In such embodiments, the control system may be configured to operate three-way valve 34 to selectively control the addition of reagent into assay fluidic line 30. In this manner, the control system may govern the selective employment of a mechanism to facilitate the activation of luminescent compounds coupled to particles in an assay, such as chemiluminescent compounds.

In alternative configurations, reagent fluidic line 38 may be coupled directly to assay fluidic line 30, such as shown in FIG. 2b. In such a case, assay inlet line 36 may be coupled to another point along assay fluidic line 30 or assay fluidic line 30 may serve as the entire inlet line, such as shown in FIG. 2b. In either case, reagent fluidic line 38 may include a valve such that a reagent may be selectively introduced into assay fluidic line 30. In some embodiments, a control system may be operably coupled to the valve to control its operation. FIG. 2b depicts the direct coupling of reagent fluidic line 38 to assay fluidic line 30 interior to interrogation flow cell 20, but it is noted that the systems described herein are not necessarily so limited. In particular, reagent fluidic line 38 may alternatively be coupled to assay fluidic line 30 exterior to interrogation flow cell 20. Likewise, the position of three-way valve 34 in FIG. 2a is not restricted to being exterior to interrogation flow cell 20. Rather, three-way valve 34 may alternatively located interior to interrogation flow cell 20. In some cases, it may be advantageous to position three-way valve 34 or the direct connection of reagent fluidic line 38 exterior to interrogation flow cell 20 such that the flow of sheath fluid within the flow cell is not disrupted.

In an alternative configuration, reagent fluidic line 38 may extend into interrogation flow cell 20 in a similar manner as assay fluidic line 30. For example, reagent fluidic line 38 may be disposed adjacent to assay fluidic line 30 as shown in FIG. 2c. Adaptations of such a configuration as well as alternations thereto are described in the U.S. patent application Ser. No. 11/938,457 entitled “Flow Cytometer and Fluidic Line Assembly with Multiple Injection Needles” by Krager et al. filed on Nov. 12, 2007, which is incorporated by reference as if set forth fully herein. In other embodiments, reagent fluidic line 38 and assay fluidic line 30 may comprise a set of nested fluidic lines extending into interrogation flow cell 20. For example, assay fluidic line 30 may be nested within reagent fluidic line 38, as shown in FIG. 2d, or vice versa.

In any case, the ends of fluidic lines 30 and 38 extending into interrogation flow cell 20 may, in some embodiments, be offset such as shown for the nested configuration of fluidic lines in FIG. 2d. An offset configuration may be particularly beneficial to facilitate better mixing of the fluids dispensed from nested lines, but a nested line configuration is not necessarily so limited. In particular, the ends of fluidic lines 30 and 38 may alternatively be arranged in alignment with each other such as shown for the non-nested configuration of fluidic lines in FIG. 2c. Although an aligned configuration may be advantageous to centralize a mixture of fluids dispensed from non-nested lines, a non-nested line configuration is not necessarily so restricted. As such, the offset and aligned arrangements of fluidic lines 30 and 38 depicted in FIGS. 2c and 2d are not mutually exclusive to their respective non-nested and nested configurations.

In any case, the different assay fluids provided through fluidic lines 30 and 38 may be mixed within interrogation flow cell 20 upon being dispensed from the multiple needles. In some cases, fluidic lines 30 and 38 may extend into interrogation flow cell 20 such that their ends are in the wide body cavity of the flow cell preceding focusing section 22. In yet other embodiments, fluidic lines 30 and 38 may extend into interrogation flow cell 20 in the vicinity of focusing section 22 as shown in FIGS. 2c and 2d. Such an embodiment may be advantageous when a chemiluminescent reaction between two assay fluids is relatively immediate and short, such as less than approximately 100 milliseconds (ms) after the two assay fluids are mixed. In contrast, mixing assay fluids in proximity to the opening of interrogation cell 20, such as described in reference to FIGS. 2a and 2b, may be suitable for embodiments in which a chemiluminescent reaction occurs between approximately 100 ms and approximately 500 ms after mixing. For example, a travel time of approximately 125 ms from the point of mixing the assay fluids to the middle of an examination zone 26 was found to be functional for the configuration outlined in FIG. 2a. Such preferred configurations relative to different ranges of time for chemiluminescent reactions may vary among different configurations of flow systems and different operational parameters. In particular, fluid flow rates and different dimensions of flow systems affecting fluid volume at different regions of the systems may generally affect the placement of joining different assay fluids for a chemiluminescent reaction.

Following the line of discussion and configurations for inducing a chemiluminescent reaction within an optical analytical system, it is contemplated that one or more means for facilitating the activation of other types of luminescent light may be incorporated within optical analytical systems. Such other types of luminescent light include: photoluminescence, fluorescence, phosphorescence, bioluminescence, crystalloluminescence, electroluminescence, cathodoluminescence, mechanolumnescence, triboluminescence, fractoluminescence, piezoluminescence, radioluminescence, sonoluminescence, and thermoluminescence. FIG. 3 is used to generally depict such alternative configurations, particularly with device 39 serving as a means to facilitate activation of a luminescent material. In general, device 39 is arranged relative to assay fluidic line 30 such that the activation of the luminescent material is conducted at a site along a flow path of the fluid assay prior to a particle examination chamber of the optical analysis system. An example of device 39 including a means for facilitating activation of a phosphorescent compound, for instance, may include an illumination system configured to illuminate a portion of assay fluidic line 30. On the contrary, an example of a means for facilitating activation of a mechanoluminescent compound, for instance, may include filaments arranged within assay fluidic line 30, which are configured to graze traversing particles. Yet another example of device 39 is a heater arranged to heat at least a portion of assay fluidic line 30 to facilitate the activation of a thermoluminescent compound.

Turning to the flowchart depicted in FIG. 4, methods for operating an optical analytical flow system configured for activating a luminescent compound on at least some particles at a site along a flow path of a fluid assay prior to an examination zone of the system and subsequently measuring the resulting luminescent light at the examination zone is illustrated. In particular, FIG. 4 includes block 40 in which a fluid assay comprising particles coupled with one or more luminescent compounds is injected into an optical analysis flow system. In general, the fluid assay may include any biological or chemical fluid in which determination of the presence or absence of one or more analytes of interest is desired.

The one or more luminescent compounds may be coupled to the particles either directly or indirectly in the same manner as photoluminescent compounds are attached to particles for conventional processing. For example, indirect coupling is provided in a “competitive” immunoassay, where antibodies specific for the analyte to be detected are coupled to the particles. A labeled luminescent antigen (i.e., a reporter) is provided and will bind to the antibodies unless an antigen (i.e., analyte) in the fluid assay out-competes the labeled antigen for a limited number of antibody binding sites on the particle. In non-competitive immunoassays, the analyte is “sandwiched” between two antibodies, the capture antibody coupled to the particle and the detection antibody with the luminescent moiety coupled thereto. In some embodiments, the one or more luminescent compounds may vary by type and/or concentration among different sets of particles. In this manner, the one or more luminescent compounds may be attributed to particular classifications of particles and multiple analytes may be analyzed via luminescent detection/measurement. It is further noted that particles of an assay may include any combination of luminescent compounds used for analyte detection, including different types of luminescent compounds on the same particle.

As further shown in FIG. 4, the method includes block 42 at which a luminescent compound coupled to at least some of the particles is activated within the optical analysis flow system at a site along a flow path of the fluid assay prior to an examination zone of the optical analysis flow system such that the particles coupled with the activated luminescent compound emit luminescent light within the examination zone. Such an activation step may include any of the processes described in reference to FIGS. 2a-3. For example, in some embodiments, the activation process referred to in block 42 may include illuminating the flow path of the fluid assay prior to the examination zone to activate, for example, phosphorescent materials coupled to particles within the fluid assay. In addition or alternatively, the activation process referred to in block 42 may include grazing particles against filaments in the flow path prior to the examination zone to activate mechanoluminescent compounds on the particles. In yet other embodiments, thermoluminescent compounds may be activated by heating the fluid assay within the flow path prior to the examination zone. Means for inducing such processes are described above in reference to FIG. 3 and are not reiterated for the sake of brevity, but are nonetheless referenced for the method outlined in FIG. 4.

As noted in block 44 in FIG. 4, an additional or alternative manner for the activation step outlined in block 42 may include introducing an activation reagent into the flow path of the fluid assay to react with a chemiluminescent compound coupled to at least some of the particles within the assay to generate chemiluminescent light. The process may be performed in any of the manners described in reference to FIGS. 2a-2d. The descriptions of such processes are not reiterated for the sake of brevity, but are nonetheless referenced for the method outlined in FIG. 4. The initial introduction of the activation agent may be conducted prior to, concurrently, or subsequent to the initial injection of the fluid assay into the optical analysis flow system. In general, the flow rate of the activation reagent is preferably selected to insure a positive flow into an interrogation flow cell of the optical analysis flow system. It is noted that the inclusion of block 44 in FIG. 4 regarding an exemplary process for implementing the process outlined in block 42 is merely presented for exemplary purposes and should not be construed to limit the method to such a process nor exclude the processes described above for activating any other types of luminescent compounds.

As noted above, the luminescent compound/s used for the assay analysis processes described herein may generally have emissions kinetics peaks which cover the timeframe it takes for a particle to travel to a particle examination zone after being triggered. In particular, the prescribed range insures luminescent light emission may be detected and measured in a particle examination zone of the optical analysis systems described herein. Chemiluminescent compounds which have been found to be particularly suitable for chemiluminescent reactions are acridinium compounds, examples of which are set forth below including biacridinium, acridinium-9 carboximide, and an N-sulfonylamide derivative of acridinium-9 carboximide. In general, such compounds have been found to have a chemiluminescent reaction between approximately 100 ms and approximately 300 ms after being triggered.

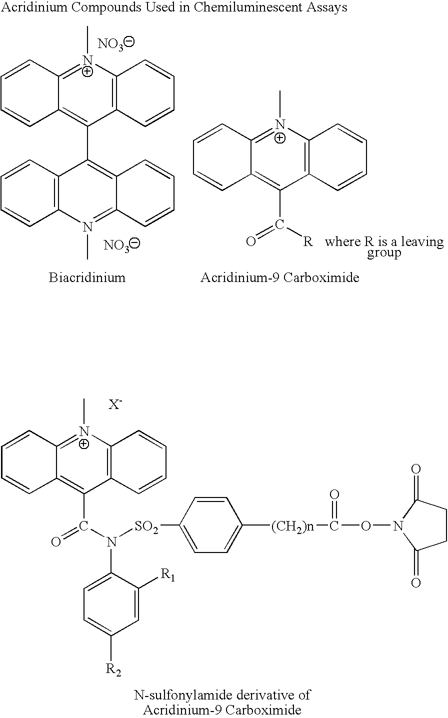

An exemplary outline of the chemical mechanism for generating the chemiluminescent light may be as follows, but other chemical mechanisms may be considered. As shown below, an acridinium salt may be mixed with hydrogen peroxide to produce acridan hydroperoxide, which in turn may develop into a tetrahedral spirodioxetane intermediate and then on to acridone in an excited state.

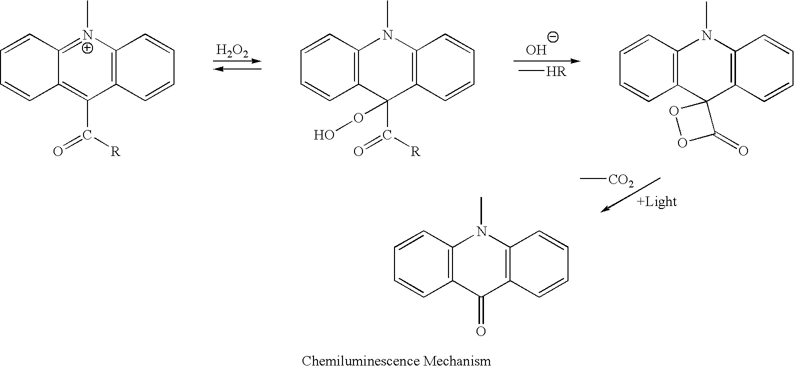

Regardless of the activation process employed for block 42, the method depicted in FIG. 4 may continue to block 46 in which luminescent light emitted and/or scattered from the particles flowing through an examination zone of the interrogation flow cell is measured. Such measurement may be indicative of the presence, absence, and/or amount of one or more analytes within an assay and may generally be performed through photodetectors and an adjoining examination system, such as described above for detection system 16 and examination system 19 of FIG. 1. As noted above, particles of an assay may include any combination of luminescent compounds used for analyte detection, including different types of luminescent compounds on the same particle. As such, in some embodiments, some of the particles in the assay may include one or more fluorescent compounds, such as but not limited to phycoerythrin. In such cases, the method may include illuminating the examination zone with a light source exterior to the interrogation flow cell and measuring fluorescent light emitting from particles flowing through the examination zone as denoted in blocks 50 and 52, respectively.

The measurement of the luminescent light denoted in blocks 46 and 52 may be performed successively, concurrently, or alternately. In some cases, as shown in block 54, it may be advantageous to block or turn off the light source for the measurement of the luminescent light relative to block 46. In particular, illumination of a particle examination chamber may mask the detection of some types of non-fluorescent light and, therefore, it may be advantageous, in some embodiments, to turn the light source off or block it when non-fluorescent luminescent light is being measured, particularly when the processes outlined in blocks 46 and 52 are performed successively or alternately. As such, in cases in which the measurements alternate, the method may include pulsing the light source on and off. In yet other embodiments, the detection system of the optical analysis flow system may include distinct detectors spaced along the examination zone of the interrogation flow cell each configured to collect the different type of luminescent light. In such cases, blocking or turning of the light source used to illuminate the examination zone may be omitted.

A dotted line is drawn to blocks 50-54 in FIG. 4 denoting their inclusion within the method is optional. Their inclusion, however, realizes a method which detects and measures two different types of luminescent light within an optical analysis flow system. Expanding on such a concept during the development of the systems and methods described herein, it was concluded that any optical analysis system (i.e., a flow system or a system which immobilizes particles for examination) may benefit from having multiple mechanisms to activate different types of luminescent materials. In particular, it was discovered that the capacity and flexibility of optical analysis systems may be increased with such mechanisms. As a result, a method was developed in which different sets of particles within an assay are analyzed with respect to distinct luminescent emissions in single optical analysis system. FIG. 5 outlines such a method.

In particular, FIG. 5 illustrates a flow chart including block 60 in which a fluid assay is introduced into an optical analysis system. The optical analysis system may be an optical analysis flow system or a static optical analysis system which immobilizes particles for examination, such as a static imaging system. As with the method described in reference to FIG. 4, the fluid assay may include any biological or chemical fluid in which determination of the presence or absence of one or more analytes of interest is desired. Prior to being injected into the optical analysis system, the fluid assay is processed to include particles coupled with multiple distinct luminescent compounds, either coupled to the surface of the particles and/or attached to the particles through a luminescent conjugate of the analyte of interest. The particles of an assay may include any combination of luminescent compounds used for analyte detection, including different types of luminescent compounds on the same particle.

As shown in block 62, the method includes measuring a first type of luminescent light emission from a first set of particles comprising the assay. The method further includes block 64 in which a second distinct type of luminescent light emission from a second set of particles comprising the assay is measured. As indicated by the double arrowed line to the right of the blocks, the steps may be performed in the opposite order and/or performed alternately. In any case, the first and second set of particles may each comprise a partial volume of the assay. The separate dispersements may include any fractions of the total volume of the assay. In some cases, the dispersements may each include 50% of the assay, but the method is not necessarily so limited. In some embodiments, the method may optionally include flushing the flow system between processes, as shown in block 66. In yet other embodiments, the processes of blocks 62 and 64 may be performed concurrently.

The aforementioned systems and methods offer several benefits to analyzing assays. In particular, a greater number analytes may be detected in a single assay when different types of luminescent detection are used for analysis relative to analysis using a single type of luminescent detection alone. For instance, it is contemplated that an assay may be tested for over two hundred different analytes and further increases are probable. Such a benefit may further be implemented without necessarily increasing the number of particles added to an assay. In particular, assays are generally fabricated with a large number of beads, typically exceeding the number needed to obtain an accurate analysis for particular analytes via fluorescent detection. As such, a portion of the particles may be additionally or alternatively used for a different type of luminescent detection, increasing the multiplexing breadth of the assay. Furthermore, the capacity of an optical analysis systems described herein may be increased without having to implement software modifications to map out additional regions for particle classification.

It will be appreciated to those skilled in the art having the benefit of this disclosure that this invention is believed to provide systems and methods for analyzing assays using one or more luminescent reporters. Further modifications and alternative embodiments of various aspects of the invention will be apparent to those skilled in the art in view of this description. For example, although the figures and description are focused on applications of flow cytometers, the system configurations and methods described herein may be applied to any optical analysis system (i.e., the systems and methods may be applied to flow systems or static systems, particularly static imaging systems). Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for analyzing an assay within an optical analysis flow system, comprising:
injecting a fluid assay comprising particles coupled with a luminescent compound into an optical analysis flow system;
activating the luminescent compound on at least some of the particles within the optical analysis flow system at a site along a flow path of the fluid assay prior to an examination zone of the optical analysis flow system such that the particles coupled with the activated luminescent compound emit luminescent light within the examination zone; and
measuring the luminescent light emitting from the particles coupled with the activated luminescent compound as they flow through the examination zone.

2. The method of claim 1, wherein the luminescent compound is a chemiluminescent compound, wherein the step of activating the chemiluminescent compound comprises introducing an activation reagent into the flow path of the fluid assay, and wherein the activation reagent is configured to react with the chemiluminescent compound to generate luminescent light.

3. The method of claim 2, wherein the chemiluminescent compound is an acridinium compound.

4. The method of claim 1, wherein the step of measuring the luminescent light comprises measuring luminescent light emitting from a given particle less than approximately 500 milliseconds after the luminescent compound on the given particle is activated.

5. The method of claim 1, wherein the luminescent compound is a non-fluorescent luminescent compound, wherein the fluid assay further comprises particles coupled with a fluorescent compound, and wherein the method further comprises:
illuminating the examination zone with a light source; and
measuring fluorescent light emitting from the particles coupled with the fluorescent compound as they flow through the examination zone.

6. The method of claim 5, further comprising selectively blocking or turning off the light source during the step of measuring the luminescent light emitted from the particles coupled with the non-fluorescent luminescent compound.

7. An optical analysis flow system, comprising:
an interrogation flow cell;
a fluid handling system comprising:
a sheath fluidic line for supplying a sheath fluid into the interrogation flow cell; and
an assay fluidic line extending into the interrogation flow cell for introducing a fluid assay into a flow of the sheath fluid within the interrogation flow cell; and
a means for facilitating activation of a luminescent material coupled to particles entrained within the fluid assay, wherein the means for facilitating activation of the luminescent material is arranged such that the activation of the luminescent material is conducted at a site along a flow path of the fluid assay prior to an examination zone of the interrogation flow cell.

8. The optical analysis flow system of claim 7, wherein the means for facilitating activation of the luminescent material is arranged such that the site of activation is less than approximately 1.0 inch from the examination zone of the interrogation flow cell.

9. The optical analysis flow system of claim 7, wherein the means for facilitating activation of the luminescent material comprises a reagent fluidic line arranged relative to the assay fluidic line for adding a reagent to the fluid assay prior to the examination zone, wherein the reagent is configured to react with the luminescent material to generate luminescent light.

10. The optical analysis flow system of claim 9, wherein the means for facilitating activation of the luminescent material further includes a three-way valve comprising:
an outlet port coupled to the assay fluidic line;
an assay inlet port coupled to an assay inlet line for introducing the fluid assay into the assay fluidic line; and
a reagent inlet port coupled to the reagent fluidic line for introducing the reagent into the assay fluidic line.

11. The optical analysis flow system of claim 7, further comprising a control system comprising a processor and program instructions executable by the processor for selectively employing the means for facilitating activation of the luminescent material.

12. The optical analysis flow system of claim 11, further comprising:
a detection system configured to collect light emitted and/or scattered from particles passing through the examination zone and further configured to generate signals representative of a degree of light gathered; and
an examination system for analyzing the generated signals, wherein the examination system comprises program instructions executable by a processor for associating a generated signal to a particular analyte of interest based on whether the means for facilitating activation of the luminescent material is employed.

13. The optical analysis flow system of claim 11, further comprising:
an illumination system configured to illuminate the examination zone of the interrogation flow cell, wherein the control system further comprises program instructions executable by the processor for selectively blocking or turning off a light source of the illumination system in conjunction with employing the means for facilitating activation of the luminescent material;
a detection system configured to collect light emitted and/or scattered from particles passing through the examination zone and further configured to generate signals representative of a degree of light gathered; and
an examination system for analyzing the generated signals, wherein the examination system comprises program instructions executable by a processor for associating a generated signal to a particular analyte of interest based on whether the light source is blocked and/or turned off when the light corresponding to the generated signals is collected.

14. The optical analysis flow system of claim 11, further comprising:
a detection system comprising distinct detectors spaced along the examination zone for respectively collecting different types of luminescent light emissions, wherein each of the distinct detectors is configured to generate signals representative of a degree of light gathered; and
an examination system for analyzing the generated signals, wherein the examination system comprises program instructions executable by a processor for associating a generated signal to a particular analyte of interest based on which of the distinct detectors generated the signal.

15. A method for analyzing a fluid assay, comprising:
introducing a fluid assay into an optical analysis system;
measuring a first type of luminescent light emission from a first set of particles comprising the fluid assay; and
measuring a second distinct type of luminescent light emission from a second set of particles comprising the fluid assay.

16. The method of claim 15, wherein the steps of measuring the first and second types of luminescent light emissions are performed sequentially.

17. The method of claim 15, wherein the steps of measuring the first and second types of luminescent light emissions are performed concurrently.

18. The method of claim 15, wherein the steps of measuring the first and second types of luminescent light emissions are alternately performed.

19. The method of claim 15, wherein the optical analysis system is an optical analysis flow system.

20. The method of claim 15, wherein the optical analysis system is a static imaging optical analysis system.

21. The method of claim 15, wherein the first and second types of luminescent light emissions are selected from the group consisting of photoluminescence, fluorescence, phosphorescence, chemiluminescence, bioluminescence, crystalloluminescence, electroluminescence, cathodoluminescence, mechanolumnescence, triboluminescence, fractoluminescence, piezoluminescence, radioluminescence, sonoluminescence, and thermoluminescence.

22. The method of claim 15, wherein the step of measuring the first type of luminescent light emission comprises measuring fluorescent light emission, and wherein the step of measuring the second distinct type of luminescent light emission comprises measuring chemiluminescent light emission.

23. An optical analysis system, comprising:
a particle examination chamber;
an assay fluidic line distinct from the particle examination chamber, but operably coupled to the particle examination chamber such that particles entrained within a fluid assay flowing in the assay fluidic line are routed to the particle examination chamber; and
at least two distinct means for respectively facilitating the activation of at least two different luminescent materials coupled to the particles.

24. The optical analysis system of claim 23, further comprising a control system comprising a processor and program instructions executable by the processor for selectively employing the distinct means for facilitating activation of the different luminescent materials.

25. The optical analysis system of claim 23, wherein at least one means for facilitating activation of one of the luminescent materials comprises a reagent fluidic line for adding a reagent to the particles, wherein the reagent is configured to react with the luminescent material to generate luminescent light.

26. The optical analysis system of claim 23, wherein at least one means for facilitating activation of the luminescent materials comprises an illumination system.

27. The optical analysis system of claim 23, wherein the optical analysis system is an optical analysis flow system.

28. The optical analysis system of claim 27, wherein at least one of the means for facilitating the activation of one of the luminescent materials is configured such that the activation of the one luminescent material is conducted at a site along a flow path of the fluid assay prior to the particle examination chamber.

29. The optical analysis system of claim 23, wherein the optical analysis system is static imaging analysis system.
